(19) United States
(12) Patent Application Publication
(10) Pub. No.: US 2026/0359415 A1
(43) Pub. Date: Nov. 12, 2026

(54) ENHANCED SECURE AUTHENTICATION SYSTEM UTILIZING DYNAMIC AVATAR INTERACTION AND ADVANCED MULTIMODAL BIOMETRIC ANALYSIS

(71) Applicants: Luke Abrams, Renton, WA (US); David Michael Gonen, Beverly Hills, CA (US)

(72) Inventors: Luke Abrams, Renton, WA (US); David Michael Gonen, Beverly Hills, CA (US)

(21) Appl. No.: 19/747,829

(22) Filed: Jul. 20, 2026

Related U.S. Application Data
(63) Continuation of application No. 19/217,606, filed on May 23, 2025.
(60) Provisional application No. 63/651,024, filed on May 23, 2024.

(51) Int. Cl. G06F 21/32

(52) U.S. Cl. CPC G06F 21/32

(57) ABSTRACT

This invention extends its capabilities in digital authentication by incorporating sophisticated behavioral and fraud detection analyses alongside dynamic avatar interaction and multimodal biometric assessments. By analyzing a wide range of user behaviors, physiological responses, and interaction nuances, the system provides a comprehensive solution that not only detects traditional forms of identity fraud but also subtle signs of coercion or evasion. This multifaceted approach ensures a highly secure and user-responsive authentication process, making it exceedingly difficult for fraudsters to manipulate or bypass.

### CROSS REFERENCE TO RELATED APPLICATIONS

This application is a continuation of U.S. Nonprovisional patent application No. Ser. No. 19/217,606, filed May 23, 2025, which claims the benefit of U.S. Provisional Patent Application No. 63/651,024, filed May 23, 2024, the entire disclosure of each of which is incorporated herein by reference.

### FIELD OF THE INVENTION

This invention relates to advanced secure authentication technologies, integrating artificial intelligence, dynamic avatar-based interaction, and sophisticated multimodal biometric analysis, aimed at providing a robust and user-friendly authentication experience for a wide range of secure transactions and services.

### BACKGROUND OF THE INVENTION

Traditional biometric authentication systems often fall short in the face of sophisticated fraud techniques, such as deepfakes, due to reliance on static biometric measures. The proposed invention addresses these shortcomings by offering a dynamic, interactive, and highly secure authentication method that leverages the latest advancements in artificial intelligence and biometric analysis.

### SUMMARY OF THE INVENTION

The invention presents a cutting-edge biometric authentication system that employs an AI-powered, interactive digital avatar combined with a comprehensive multimodal biometric analysis technique. This system is uniquely capable of authenticating users with unparalleled accuracy, utilizing a blend of mature computer vision models and state-of-the-art transformer-based vision models for facial recognition, alongside advanced large language models (LLMs) for conversational analysis. This approach not only enhances security against fraud but also improves the user experience through natural, engaging interactions.

### BRIEF DESCRIPTION OF THE DRAWINGS

FIG. 1 illustrates an overview of the system architecture, highlighting the integration of the LLM, digital avatar, and the dual-model facial recognition system.

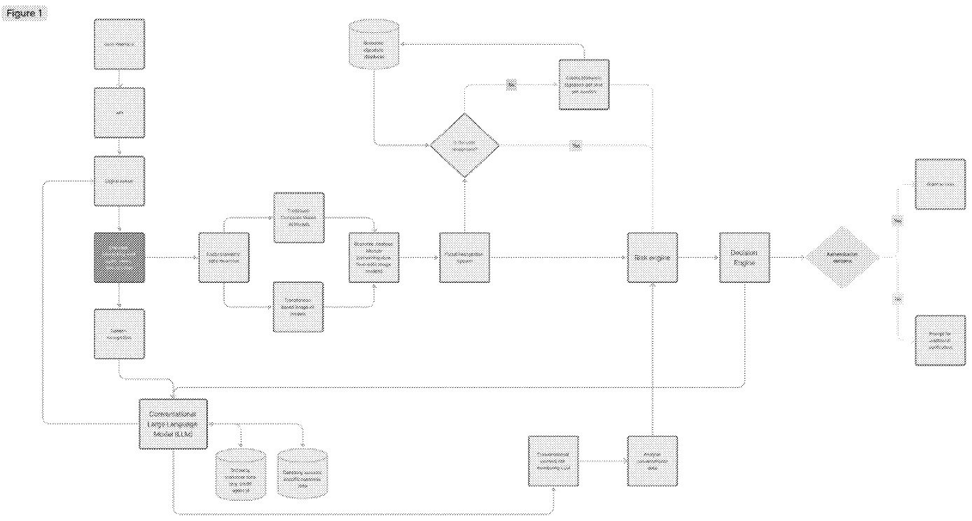

FIG. 2 illustrates a detailed flowchart of the authentication process, illustrating the steps from user engagement to authentication outcome, across various user scenarios.

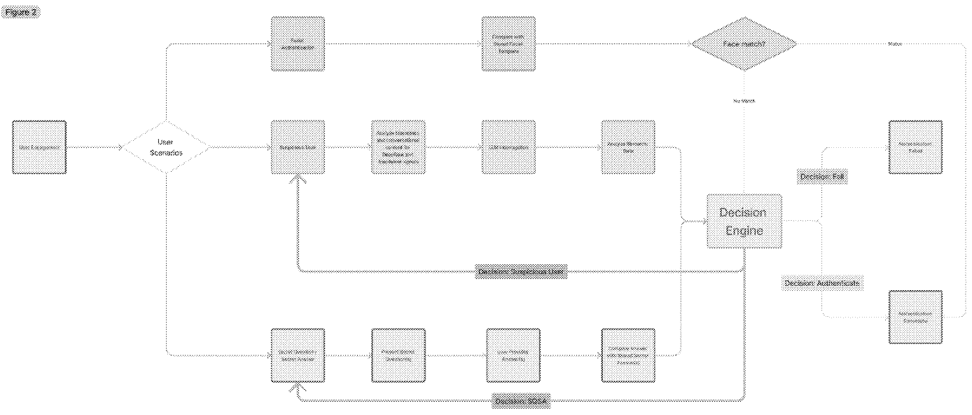

FIG. 3 illustrates an interface depiction showing a user interaction with the digital avatar, emphasizing the system's application in a password reset scenario.

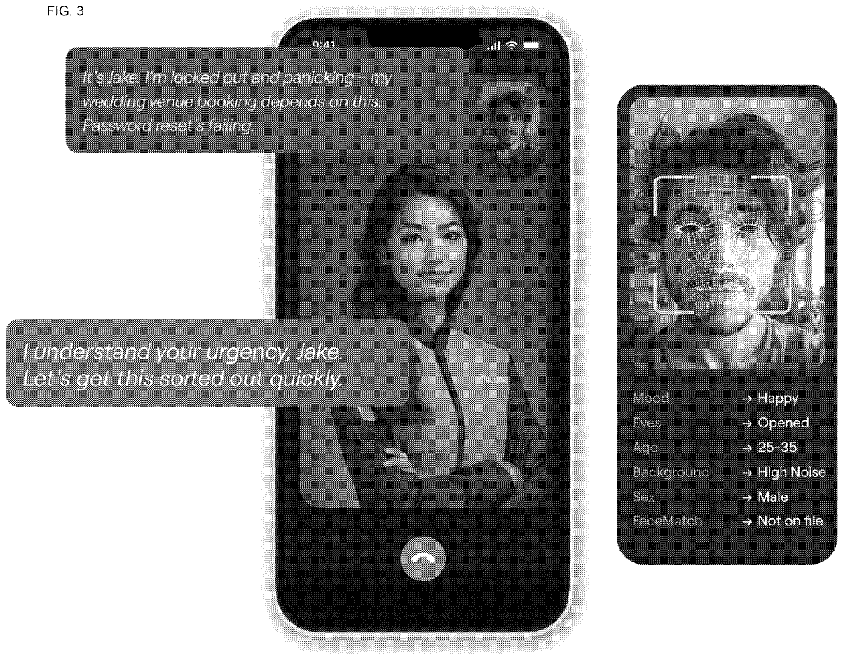

### DETAILED DESCRIPTION OF PREFERRED EMBODIMENTS

### Large Language Model (LLM)

At the heart of the interactive component is a sophisticated LLM that drives the digital avatar, enabling it to engage users in meaningful conversations. The LLM is adept at analyzing conversational nuances, including tone, content consistency, and language use, to authenticate the user based on known customer profiles.

### Real-Time Avatar

The digital avatar serves as the interactive face of the system, designed to emulate human conversational behaviors, thereby facilitating a more natural and engaging user authentication process.

### Biometric Data Collection and Analysis

### (1) Facial Biometrics:

The system employs a dual approach, combining traditional computer vision-based ML models with advanced transformer-based vision models, providing a robust framework for facial recognition that leverages the strengths of both mature and cutting-edge technologies.

### (2) Conversational Analysis:

Leveraging the LLM's capabilities, the system analyzes the conversational content for authenticity, scrutinizing the tone of voice and consistency of information with known customer data, including chosen language, language proficiency, accent, and historical interactions.

### Security Protocols

The invention incorporates leading-edge security protocols and is in the process of obtaining compliance certifications from ISO, GDPR, PCI, and other relevant standards, ensuring the highest levels of data protection, privacy, and control.

### Application Integration and Use Cases

The system is designed for seamless integration into client platforms via a RESTful API or SDK, supporting a wide array of use cases such as password resets, suspicious transaction verification, account recovery, and more, thereby significantly enhancing the security and efficiency of customer service operations.

### Enhanced Behavioral Analysis Techniques

### (1) User Actions as Fraud Signals:

The system can now monitor and analyze various user actions during the authentication session that may indicate attempts at fraud or evasion. Actions such as turning off the camera, covering the camera lens, muting the microphone, or any physical obscuring of the user's face (e.g., wearing sunglasses, face masks, hats, or scarves) are flagged as potential fraud signals.

The avatar can interactively request the user to remove any obscuring items and ensure proper visibility and audibility for accurate identification and analysis.

### (2) Behavioral and Physiological Signs of Deception or Coercion:

(a) Advanced algorithms analyze visible signs of sweating, nervousness, and other physiological responses that may indicate stress or deception. The system also evaluates the user's behavior for signs of being under the influence, such as slurring or stuttering speech, and overall mood, including any shifts in mood during the session that might suggest discomfort or evasion.

(b) Behavioral metrics such as response timing, hesitation, and confidence level in answering questions are monitored to assess the genuineness and spontaneity of the responses.

### (3) Coercion Detection and Liveness Verification:

The authentication process includes checks for coercion detection by analyzing the context and environment around the user, looking for any signs of duress or third-party presence. Liveness detection is enhanced to not only verify physical presence but also ensure the active participation of the user without any external influence or interference.

What is claimed is:

1. A computer-implemented method for secure user authentication, comprising, by one or more processors: engaging a user in a real-time interactive session, at a client device having a camera and a microphone, with a digital avatar that is driven by a large language model and emulates human conversational behavior; generating a facial-recognition result by analyzing, using a combination of a computer-vision model and a transformer-based vision model, imagery of the user captured by the camera during the session, and comparing a result thereof to known data for the user; generating a conversational-analysis result by analyzing, with the large language model, the user's responses for consistency of information with known data about the user, including at least one of a tone of voice, a content consistency, a chosen language, a language proficiency, an accent, or a historical interaction of the user; evaluating a deception indicium of the user comprising a visible sign of sweating or nervousness indicative of stress or deception, and, separately, a coercion indicium of the user determined by analyzing a context and environment around the user for a sign of duress or of a third-party presence; monitoring behavioral metrics of the user comprising a response timing, a hesitation, and a confidence level of the user in answering questions, to assess a genuineness and spontaneity of the user's responses; determining a free-participation result indicating whether the user is participating actively and free of external influence or interference, the free-participation result being based at least in part on the coercion indicium and the assessed genuineness and spontaneity; and determining an authentication outcome based on the facial-recognition result and the conversational-analysis result, wherein an authentication that would otherwise succeed based on the facial-recognition result and the conversational-analysis result is withheld or flagged when the free-participation result does not indicate that the user is participating actively and free of external influence or interference, and wherein a deception determination based on the deception indicium triggers a requirement for additional verification.

2. The method of claim 1, wherein the coercion indicium comprises a detected third-party presence in the context and environment around the user.

3. The method of claim 1, wherein evaluating the deception indicium further comprises evaluating a sign of the user being under an influence, comprising slurring or stuttering speech, and a shift in a mood of the user during the session indicative of discomfort or evasion.

4. The method of claim 1, further comprising detecting that the user has turned off the camera, covered a lens of the camera, muted the microphone, or physically obscured the user's face by wearing sunglasses, a face mask, a hat, or a scarf, and causing the digital avatar to interactively request that the user remove the obscuring item to ensure proper visibility and audibility.

5. The method of claim 1, wherein the requirement for additional verification triggered by the deception determination is output by a decision engine and comprises a prompt for additional verification.

6. The method of claim 1, further comprising creating a biometric signature for the user for the session, comparing the biometric signature against a database of biometric signatures, and applying a risk engine and a decision engine to the facial-recognition result and the conversational-analysis result, wherein the authentication outcome or the requirement for additional verification is output by the decision engine.

7. The method of claim 1, wherein the session is invoked in response to a password reset, a suspicious transaction, or an account recovery request, and the method is integrated into a client platform via a RESTful API or an SDK.

8. A system for secure user authentication, comprising one or more processors and memory storing instructions that, when executed by the one or more processors, cause the system to: engage a user in a real-time interactive session, at a client device having a camera and a microphone, with a digital avatar that is driven by a large language model and emulates human conversational behavior; generate a facial-recognition result by analyzing, using a combination of a computer-vision model and a transformer-based vision model, imagery of the user captured by the camera during the session, and comparing a result thereof to known data for the user; generate a conversational-analysis result by analyzing, with the large language model, the user's responses for consistency of information with known data about the user, including at least one of a tone of voice, a content consistency, a chosen language, a language proficiency, an accent, or a historical interaction of the user; evaluate a deception indicium of the user comprising a visible sign of sweating or nervousness indicative of stress or deception, and, separately, a coercion indicium of the user determined by analyzing a context and environment around the user for a sign of duress or of a third-party presence; monitor behavioral metrics of the user comprising a response timing, a hesitation, and a confidence level of the user in answering questions, to assess a genuineness and spontaneity of the user's responses; determine a free-participation result indicating whether the user is participating actively and free of external influence or interference, the free-participation result being based at least in part on the coercion indicium and the assessed genuineness and spontaneity; and determine an authentication outcome based on the facial-recognition result and the conversational-analysis result, wherein an authentication that would otherwise succeed based on the facial-recognition result and the conversational-analysis result is withheld or flagged when the free-participation result does not indicate that the user is participating actively and free of external influence or interference, and wherein a deception determination based on the deception indicium triggers a requirement for additional verification.

9. A non-transitory computer-readable medium storing instructions that, when executed by one or more processors, cause the one or more processors to: engage a user in a real-time interactive session, at a client device having a camera and a microphone, with a digital avatar that is driven by a large language model and emulates human conversational behavior; generate a facial-recognition result by analyzing, using a combination of a computer-vision model and a transformer-based vision model, imagery of the user captured by the camera during the session, and comparing a result thereof to known data for the user; generate a conversational-analysis result by analyzing, with the large language model, the user's responses for consistency of information with known data about the user, including at least one of a tone of voice, a content consistency, a chosen language, a language proficiency, an accent, or a historical interaction of the user; evaluate a deception indicium of the user comprising a visible sign of sweating or nervousness indicative of stress or deception, and, separately, a coercion indicium of the user determined by analyzing a context and environment around the user for a sign of duress or of a third-party presence; monitor behavioral metrics of the user comprising a response timing, a hesitation, and a confidence level of the user in answering questions, to assess a genuineness and spontaneity of the user's responses; determine a free-participation result indicating whether the user is participating actively and free of external influence or interference, the free-participation result being based at least in part on the coercion indicium and the assessed genuineness and spontaneity; and determine an authentication outcome based on the facial-recognition result and the conversational-analysis result, wherein an authentication that would otherwise succeed based on the facial-recognition result and the conversational-analysis result is withheld or flagged when the free-participation result does not indicate that the user is participating actively and free of external influence or interference, and wherein a deception determination based on the deception indicium triggers a requirement for additional verification.
